(19) United States
(12) Patent Application Publication
(10) Pub. No.: US 2025/0116260 A1
(43) Pub. Date: Apr. 10, 2025

(54) ENERGY RECOVERY SYSTEM

(71) Applicant: John Bean Technologies (Proprietary) Limited, Brackenfell (ZA)

(72) Inventor: Willie Petrus Kitching, Cape Town (ZA)

(73) Assignee: John Bean Technologies (Proprietary) Limited, Brackenfell (ZA)

(21) Appl. No.: 18/907,960

(22) Filed: Oct. 7, 2024

Related U.S. Application Data
(60) Provisional application No. 63/589,265, filed on Oct. 10, 2023.

(51) Int. Cl. F03G 7/08; A23N 1/00; H02J 3/32

(52) U.S. Cl. CPC F03G 7/08; A23N 1/003; F05B 2240/85; F05B 2270/504; F05B 2270/602; F05B 2270/706; H02J 3/32

(57) ABSTRACT

An energy recovery system for machines each having a mechanical power transmission system that generate energy in a first portion of a mechanical power transmission system cycle and draw energy from an energy source in a second portion of the cycle incudes a power distribution assembly configured to receive energy generated during the first portion of the cycle, a plurality of actuator controller devices configured to selectively output energy to a corresponding actuator of each of the plurality of machines, each of the plurality of actuator controller devices electrically coupled to the power distribution assembly and configured to reuse energy received by the power distribution assembly, and, a controller for each of the plurality of actuator controller devices programmed to adjust the output energy of the corresponding actuator controller device to substantially maintain a voltage level of the power distribution assembly relative to a voltage level setpoint.

### CROSS-REFERENCE TO RELATED APPLICATION

This application claims the benefit of U.S. Provisional Application No. 63/589,265, filed Oct. 10, 2023, the entire contents of which are incorporated herein by reference.

### BACKGROUND

Industrial juice (e.g., citrus) extractors often include a series of juice extractor units that are ganged together. Each juice extractor unit includes upper and lower cups for supporting the fruit. The sides of both upper and lower cups have fingers that intermesh or interdigitate together. The upper cups are mounted on a common cross bar, which moves in a fixed up and down path by means of a cam-drive positioned at the top of the juice extractor machine. The upper cups move into the bottom cups, which remain rigidly positioned.

A fruit, such as an orange, is initially fed into the bottom cup such as by a cam-operated feeding device. The upper cup then descends into the lower cup. The fruit is pressed against sharp circular cutters positioned at the top of a strainer tube adjacent the lower cup, and an upper cutter positioned in the upper cup. The two circular cutters cut plugs into both the top and bottom portions of the fruit as the interdigitating fingers of the two cups mesh together. At the same time, the inner portions of the fruit (i.e., the pulp and juice) are forced down into the strainer tube positioned within a manifold.

More specifically, the upper cup moves downward rapidly until it contacts the fruit, at which time the speed slows down to the squeezing stroke. As soon as the pressure on the fruit is sufficient, the lower cutter cuts a round hole in the bottom of the fruit. By this time the two cups are meshed together so that the fruit is completely encircled. During this squeezing stroke, an orifice beam supporting an orifice tube is at its lowest position. As the upper cup comes down, the fruit is squeezed and the peel plugs, juice, membrane, and seeds are forced down through the lower cutter into the strainer tube.

The peeled surfaces of the fruit do not contact the juice as the interdigitating fingers peel the fruit. After the upper cup has descended toward the lower cup, an orifice tube moves upward into the strainer tube. The orifice tube includes a restrictor in its lower end. The orifice tube applies pressure into the internal portion of the strainer tube to separate juice and pulp within the strainer tube, collect the core material and discharge the core material out of the bottom of the orifice tube. The core material typically includes membrane, seeds and peel plugs.

As the orifice beam approaches the top of its stroke, the upper cup starts upward slowly. As the orifice beam reaches the top of its stroke the upper cups accelerate rapidly so that the upper cup is out of the way to allow the next fruit to be fed into the lower cup. The orifice beam then drops rapidly, leaving the strainer tube cleared and ready to accept the juice from the next fruit.

Each of the upper and lower cups, together with the strainer tube and orifice tube, form a single juice extractor unit. As noted above, three or more juice extractor units are typically ganged together to increase production and are positioned in one housing. The orifice tubes may include a mounting assembly that is ganged together, such as by a drive beam that supports each of the mounting assemblies and is moveable to reciprocate the orifice tubes within the strainer tube.

Improved juice extractor systems and methods or similar machines or method will now be described.

### SUMMARY

In some aspects, the techniques described herein relate to an energy recovery system for a plurality of machines each having a mechanical power transmission system, wherein each of the plurality of machines generates energy in a first portion of a mechanical power transmission system cycle and draws energy from an energy source in a second portion of the mechanical power transmission system cycle, the energy recovery system including: a power distribution assembly configured to receive energy generated during the first portion of the mechanical power transmission system cycle; a plurality of actuator controller devices configured to selectively output energy to a corresponding actuator of each of the plurality of machines, each of the plurality of actuator controller devices electrically coupled to the power distribution assembly and configured to reuse energy received by the power distribution assembly; and a controller for each of the plurality of actuator controller devices programmed to adjust the output energy of the corresponding actuator controller device to substantially maintain a voltage level of the power distribution assembly relative to a voltage level setpoint.

In some aspects, the techniques described herein relate to an energy recovery system, including: a plurality of machines each having a mechanical power transmission system powered by an electrical motor, wherein the electrical motor of each of the plurality of machines generates energy in a first portion of a mechanical power transmission system cycle; a DC common bus configured to receive energy generated during the first portion of the mechanical power transmission system cycle; a plurality of variable frequency drives (VFDs) configured to selectively output energy to the corresponding electrical motor of each of the plurality of machines, each of the plurality of VFDs electrically coupled to the DC common bus and configured to reuse energy received by the DC common bus; and a PID controller for each of the plurality of VFDs programmed to adjust the output energy of the corresponding VFD to substantially maintain a voltage level of the DC common bus relative to a voltage level setpoint.

In some aspects, the techniques described herein relate to an energy recovery system for a juice extractor system having a plurality of juice extractor machines, wherein each juice extractor machine generates energy during a first portion of a mechanical power transmission system juicing cycle and draws energy from an energy source during a second portion of the mechanical power transmission system juicing cycle, the energy recovery system including: a power distribution assembly configured to receive energy generated during the first portion of the mechanical power transmission system juicing cycle; a plurality of actuator controller devices configured to selectively output energy to a corresponding actuator of each of the plurality of juice extractor machines, each of the plurality of actuator controller devices electrically coupled to the power distribution assembly and configured to reuse energy received by the power distribution assembly; and a controller for each of the plurality of actuator controller devices programmed to adjust the output energy of the corresponding actuator controller device to substantially maintain a voltage level of the power distribution assembly relative to an energy level setpoint.

In some aspects, the techniques described herein relate to a method of recovering energy for a plurality of machines each having an actuator controller device that supplies energy to an actuator for moving components of the machine between a first portion of a mechanical power transmission system cycle and a second portion of a mechanical power transmission system cycle, the method including: supplying output energy from each actuator controller device to the corresponding actuator; generating energy by each of the actuators during the first portion of the mechanical power transmission system cycle of each of the plurality of machines; dissipating generated energy below a predetermined energy level to a power distribution assembly electrically coupled to each actuator controller device; and dissipating supplemental generated energy above the predetermined energy level to a power dissipation device.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is an isometric view of an exemplary juice extractor system for use with an energy recovery system in accordance with examples of the present disclosure.

FIG. 2A is an isometric view of an exemplary juice extractor machine for use with an energy recovery system in accordance with examples of the present disclosure.

FIG. 2B is a front view of an exemplary juice extractor machine for use with an energy recovery system in accordance with examples of the present disclosure.

FIG. 2C is a side view of an exemplary juice extractor machine for use with an energy recovery system in accordance with examples of the present disclosure.

FIG. 3 is a block diagram of an exemplary energy recovery system in accordance with examples of the present disclosure.

FIGS. 4A and 4B are electrical diagrams of portions of an exemplary energy recovery system in accordance with examples of the present disclosure.

FIG. 5 is a schematic illustration of energy generation for a system using a plurality of juice extractor machines electrically coupled to corresponding variable frequency drives (VFDs).

FIG. 6 is a schematic illustration of energy generation and reuse for an energy recovery system using a plurality of juice extractor machines having motors electrically coupled to corresponding VFDs on a common DC bus, wherein the juice extractor machines operate out of phase.

FIG. 7 is a flowchart that illustrates an exemplary method for reusing energy in accordance with examples of the present disclosure.

FIG. 8 is a graphical representation of energy consumption of the system of FIG. 5 compared to the reduced energy consumption of the system of FIG. 6.

FIG. 9 is a schematic diagram of a PID control loop.

FIG. 10 is a schematic illustration of energy generation and reuse for a system using a plurality of juice extractor machines having motors electrically coupled to corresponding VFDs on a common DC bus, wherein the juice extractor machines operate substantially in phase (e.g., in sync).

FIG. 11 is a flowchart that illustrates an exemplary method for optimizing energy usage of a juice extractor system in accordance with examples of the present disclosure.

FIG. 12 is a block diagram that illustrates a non-limiting example of a computing device appropriate for use with examples of the present disclosure.

### DETAILED DESCRIPTION

Systems and methods disclosed herein relate to an energy recovery system for a plurality of machines having cyclical movement that draws energy from an energy source in a first portion of a cycle and generates energy in a second portion of the cycle. In general, the energy recovery system is configured to optimize the recovery of energy generated by the machines during the second portion of the cycle such that the recovered energy may be used by the machines or their associated components during the first portion of the cycle.

In some aspects, systems and methods disclosed herein relate to a machine performing a reciprocating action through an electric motor, which may produce a regenerative current during the reciprocating action. The energy recovery system may be configured to channel or redirect regenerative electrical current or energy generated by such machines.

Electric motors are widely used to power drive mechanisms and mechanical power transmission systems, including those used in machines performing a reciprocating action. In such machines, the rotary motion the motor generates may be translated into a linear movement to perform work. The linear movement may be reciprocal in that it drives an object or tool back and forth along a general axis. Such reciprocating machines may be bi-directional in that the linear movement reverses, returning to an initial position with each completed cycle of operation.

An example of a machine performing a reciprocating motion is in fruit juicing machines, often referred to as “juicers”. Juicers which employ a reciprocating mechanism are well-known and described in, for example U.S. Pat. Nos. 2,649,730, 2,780,988, and 4,309,943, 7,156,016, and Patent Cooperation Treaty (PCT) Application No. 2006/023220, all of which are incorporated herein by reference in their entirety.

The exemplary systems and methods will be hereinafter described with reference to a juice extractor system having a plurality of juice extractor machines (e.g., citrus extractor machines). In the exemplary systems and methods described herein, the energy recovery system is configured to capture energy generated by the juice extractor machines in a first portion of a juicing cycle (e.g., a downward mechanical movement to extract juice) and reuse that captured energy for driving the machines or related components in second portion of the juicing cycle (e.g., in an upward reciprocal mechanical movement to retract the juicing components).

Although the exemplary systems and methods are described with reference to a juice extractor system having a plurality of juice extractor machines, it should be appreciated that the systems and methods described herein may be adapted for use with other systems using similar mechanical and electrical components.

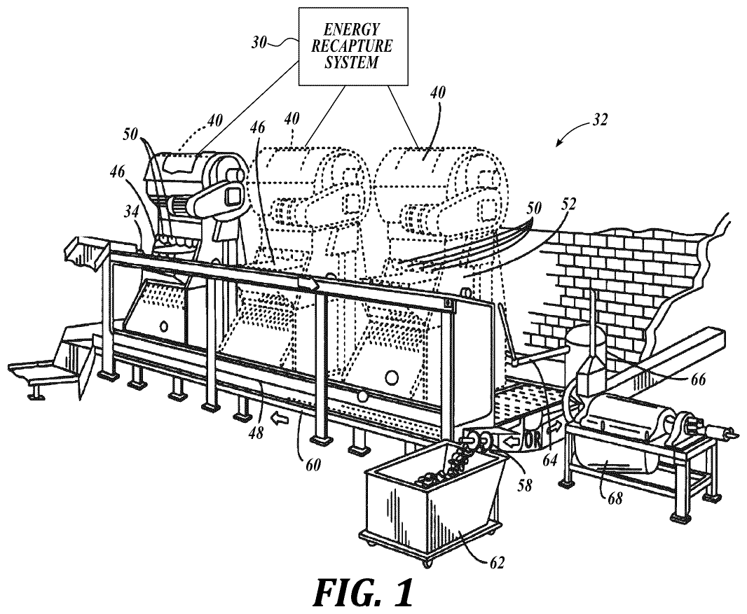

An exemplary juice extractor system 32 for use with an energy recovery system 30 will now be described with respect to FIG. 1. In the depicted example, the juice extractor system 32 includes a plurality of juice extractor machines 40. Each juice extractor machine 40 includes individual juice extractor units 50 (illustrated as five units) that are ganged together in a common extractor frame 52 forming a juice extractor machine 40. The juice extractor unit 50 defines respective juice extractor positions where an individual fruit is received on a fixed extractor cup and compressed or squeezed by a respective moveable extractor cup. The fixed and moveable extractor cups can be horizontally aligned and/or aligned vertically. With vertically aligned extractor cups as illustrated, the fixed extractor cup is typically a lower extractor cup and the moveable extractor cup is typically an upper extractor cup.

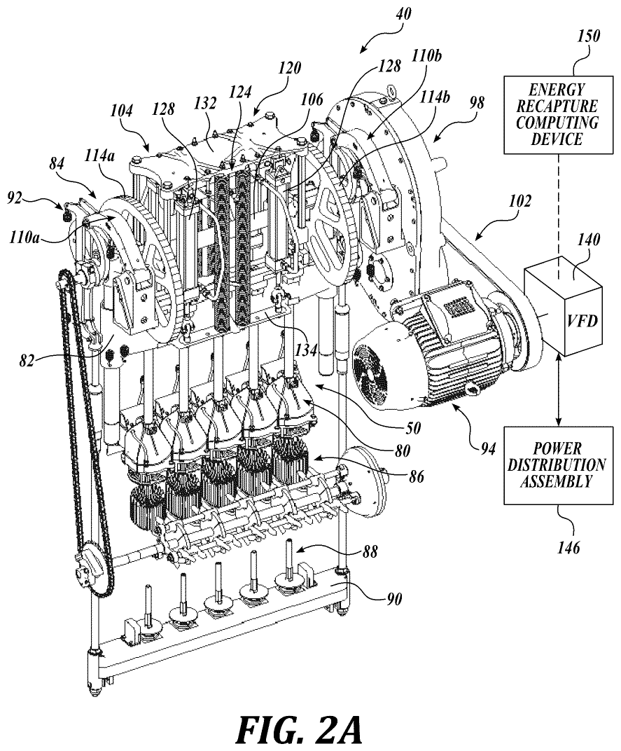

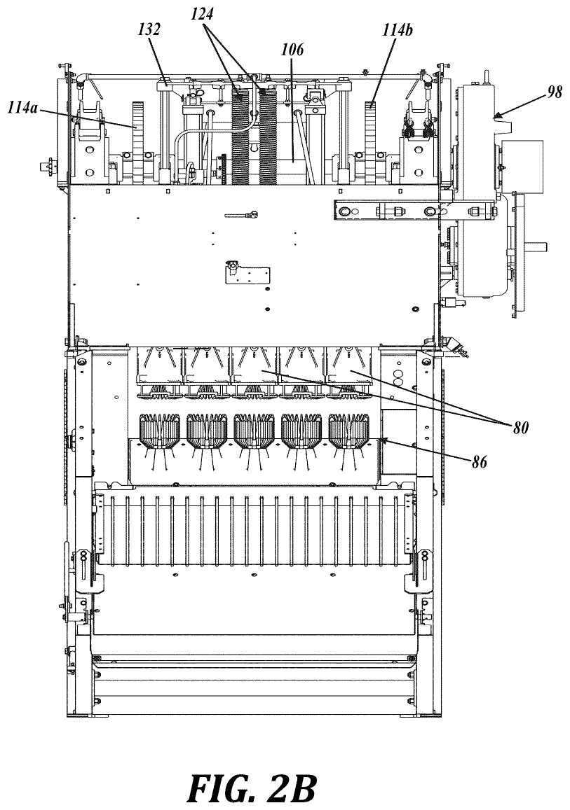

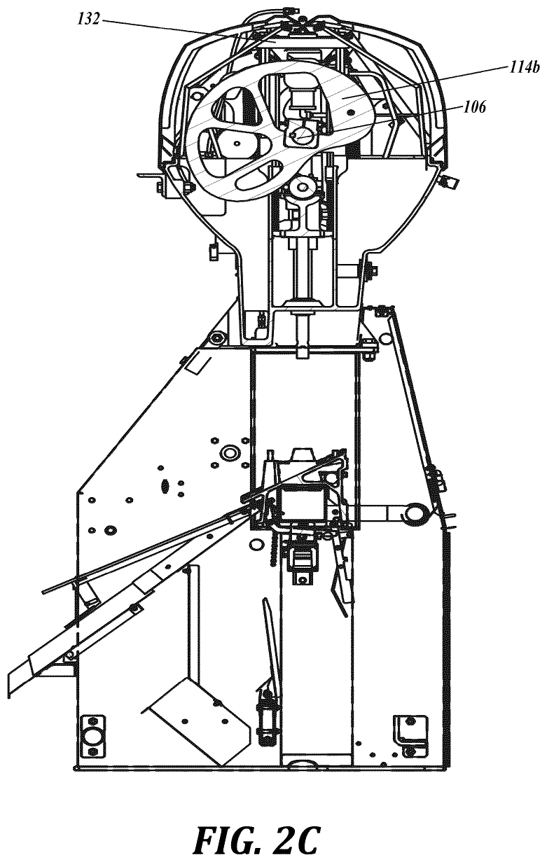

To perform a juicing operation, the fruit (e.g., an orange, lemon, lime, grapefruit, etc.) may be moved to feed hoppers 46 of the juice extractor machine 40 (such as through a feed belt conveyor 34) that guides fruit into a fixed, e.g., lower extractor cup (not shown). The fruit is typically separated into three primary product streams, a pulpy juice, the peel, and the fruit material that enters an orifice tube (see orifice tubes 88 in FIG. 2). The waste peel may be directed onto a peel screw 58 located under the juice extractor platform 60 and is discharged into a discharge hopper 62 or other waste disposal container, or it can be conveyed through an exterior wall to a truck or trailer, or to further processing.

Typically, the juice extractor machines 40 are supported on an elevated platform 60 not only to provide support for the juice extractors, but also to provide access for mechanical operation and maintenance. The juice from the various juice extractor machines 40 may enter a stainless steel discharge header 64 extending from each juice extractor and is gravity fed into a surge tank 66 that is designed to maintain a constant flow of juice, preferably to an optional finisher 68. The finisher may further remove pulp from the juice by using stainless steel screens with small perforations. A finisher 68 typically is used when a number of juice extractors are placed in tandem, as illustrated.

The juice can be pumped from the surge tank 66 or finisher 68. The juice extraction process shown in FIG. 1 is illustrative of a small juice extraction facility. Larger juice extraction facilities are similar in process, but are larger in scale and may include additional equipment known to those skilled in the art. Additional equipment (not shown) may include bucket elevators for lifting and conveying fruit; fruit storage bins for temporary storage of unloaded fruit; sizing equipment for sorting fruit based on size; byproduct recovery systems such as pulpwash systems, and oil recovery systems; feedmills for drying of peel waste; and pasteurizers and evaporators for the processing of juice. These and other equipment are known to those skilled in the art.

A general description of an overall juice extraction process from fruit unloading to final processing and waste handling is described in U.S. Pat. No. 7,156,016, entitled “Juice extractor with integral juice manifold and cup bridge,” the entire disclosure of which is hereby incorporated by reference herein.

FIG. 2 show a single juice extractor machine 40 with the outer covers, external electrical box, air hose, protruding housing members, etc., removed to show internal mechanical components of the extractor. Although not all of the mechanical components of the juice extractor machine 40 will be described in detail, a brief overview will now be provided for understanding aspects of the energy recovery system 30. As noted above, the juice extractor machines 40 are exemplary only, and other juice extractor configurations may instead be used without departing from the scope of the present disclosure. Moreover, the energy recovery system 30 may instead be adapted for use with any suitable machine.

In the exemplary juice extractor machine 40 depicted, a plurality of moveable, upper extractor cups 80 are mounted on a common cross bar, i.e., a cup support member or cup beam 82. The cup beam 82 is reciprocated by a rotating cam-operated drive system 84 contained within or otherwise secured to an upper portion of the juice extractor as described further below. Fixed, lower extractor cups 86 are rigidly positioned relative to the moveable extractor cups 80 and mounted on a cup bridge (not shown). As described above, the moveable and fixed extractor cups 80 and 86 may be formed as interdigitated extractor cups having fingers that intermesh together when the moveable extractor cups 80 engages fixed extractor cups 86.

The moveable and fixed extractor cups 80 and 86 and their associated components, such as the associated cup bridge, a prefinisher strainer tube (not shown), and orifice tubes 88 form one juice extractor unit 50. As illustrated in FIG. 2, a number of juice extractor units 50 are ganged together in one juice extractor machine 40 to increase production. The illustrated juice extractor machine 40 includes five juice extractor units 50 positioned at respective juice extracting positions.

The exemplary rotating cam-operated drive system 84, which is configured to reciprocate the cup beam 82, will now be further described with reference to FIG. 2. In general, the rotating cam-operated drive system 84 includes a mechanical power transmission system powered by an an actuator, such as an electrical drive motor 94. The actuator may be an electrical drive motor 94, such as an alternating current (AC) motor, that receives power from an AC or “mains” supply. In an industrial setting, this may be a three-phase mains supply.

The electrical drive motor 94 is mechanically coupled to the mechanical power transmission system of the cam-operated drive system 84 for reciprocating the cup beam 82. In the example shown, a drive motor output shaft (not shown) of the electrical drive motor 94 may connect to a large drive gear 98 (shown enclosed in a housing) through a suitable mechanical connection, such as a drive belt 102. The large drive gear 98 is connected by a gear train to an extractor frame mounted camshaft 106.

The camshaft 106 supports a cup cam subassembly 104 of the cam-operated drive system 84. The cup cam subassembly 104 is configured to force the moveable, upper extractor cups 80 into the fixed, lower extractor cups 86 for performing the juicing step.

Although any suitable cup cam subassembly may be used, in the example shown, the cup cam subassembly 104 is shown having first and second cup drive cams 114a and 114b near first and second ends of the camshaft 106. A pair of first cam follower mechanisms (not shown), which are operably connected to the cup beam 82, engages each of the cup drive cams 114a and 114b. As the driven camshaft 106 rotates, the cup drive cams 114a and 114b rotate against the respective first cam follower mechanisms and ultimately force downward the cup beam 82. The fixed, upper extractor cups 80, supported on the cup beam 82, are moved downward into engagement with the lower, fixed extractor cups 86. As this occurs, fruit received within the fixed, lower extractor cups is pressed against respective cutters to perform the juicing process.

The cup cam subassembly 104 of the cam-operated drive system 84 may also be configured for returning the cup beam 82 into a disengaged (e.g., raised) position. More specifically, the cup cam subassembly 104 may include a pair of second cam follower mechanisms operably connected to the cup beam 82, which engage each of the cup drive cams 114a and 114b. As the driven camshaft 106 rotates further (or in some examples, in an opposite direction), the cup drive cams 114a and 114b rotate against the respective second cam follower mechanisms and ultimately force the cup beam 82, as well as the fixed, upper extractor cups 80, back upward. As a result, the upper, moveable extractor cups 80 are disengaged from the lower, fixed extractor cups 86. The second cam follower mechanisms may be formed as a mathematical conjugate of the first cam follower mechanisms to hold the cam followers to the cup drive cams 114a and 114b and lift the cup beam 82 during the juice extraction cycle.

The cam-operated drive system 84 may advantageously incorporate a return biasing subassembly 120. The return biasing subassembly 120 is configured to assist in moving the cup beam 82 upward. In other words, the return biasing subassembly 120 pulls upward on the cup beam 82, helping to return the cup beam 82 to its initial position. The return biasing subassembly 120 may include any suitable biasing devices, such as one or more extension springs 124 and one or more gas springs 128 that extend between an upper fixed support 132 (e.g., fixed to the extractor frame) and a lower support 134 secured to and moveable with the cup beam 82. As the cup beam 82 is forced downwardly by the cup cam subassembly 104 into its fully extended position, the biasing members of the return biasing subassembly 120 (e.g., the one or more extension springs 124 and the one or more gas springs 128) are pulled into an extended state, storing energy. The stored energy of the return biasing subassembly 120 pulls upward on the cup beam 82, helping to return it to its initial position and reducing the energy required from the motor 94.

In some examples, the cam-operated drive system 84 may further incorporate a drive biasing subassembly similar to the return biasing subassembly 120. In such an example, the drive biasing subassembly would help drive the downward movement of the cup beam 82 into its fully extended, juicing position, reducing the energy required from the motor 94 on the downward stroke.

A counterweight can be mounted to the main drive gear located within the gearbox, or mounted on the camshaft 106 that supports the cup cam subassembly 104. The counterweight can provide balance to the machine during extractor operation.

The camshaft 106 may also support an orifice beam cam assembly 92 having first and second orifice beam drive cams 110a and 110b on the outer ends of the camshaft, which similarly engage cam follower mechanisms (not shown) to reciprocate an orifice beam 90 supporting the orifice tubes 88. In that regard, one or more biasing mechanisms (not shown) may be incorporated into the orifice beam cam assembly 92, such as to pull upward on the orifice beam 90, helping to return the orifice beam 90 to its initial position and forcing the orifice tube into the strainer tube for the juice extraction process.

In order to support desired throughput or operational conditions of the juice extractor system 32, it is often desired to adjust the extraction speed of the juice extractor machines 40. For instance, if a higher juicing throughput is needed, it may be necessary to increase the reciprocation speed of the cup beam 82 and the orifice beam 90. Typically, the reciprocation speed is changed by mechanically adjusting components of the cam-operated drive system 84 and the orifice beam cam assembly 92, as is well known in the art.

In the systems and methods disclosed herein, the reciprocation speed of the cup beam 82 and the orifice beam 90 of a juice extractor machine 40 is adjusted with an actuator or motor controller electrically coupled to the electrical drive motor 94 of the juice extractor machine 40. The motor controller may adjust the output speed of the motor by varying the frequency and voltage of the input electricity to the motor. For instance, the motor controller may draw energy from an energy supply (e.g., an AC mains), store the drawn energy in a storage device (e.g., a capacitor), and convert the stored energy to an AC current supplied to the electric motor 94.

Although any suitable motor controller may be used, in the systems and methods disclosed herein, the motor controller is described as a variable frequency drive or VFD 140 (also sometimes known as an “inverter” or a “VFD frequency inverter”). It should be appreciated that the systems and methods disclosed herein may be adapted for use with other motor controllers, such as a soft starter, a contactor, etc.

In examples herein, the motor controller, e.g., the VFD 140, is part of the energy recovery system 30 for the juice extractor system 32 shown in FIG. 1 and other FIGS. described below. The energy recovery system 30 may be used to capture energy generated by the juice extractor machines 40 and reuse that captured energy for driving the machines of the juice extractor system 32 or other components of the juice extractor system 32 associated with the machine or system.

In one example, each of the plurality of juice extractor machines 40 generates energy in a first portion of a mechanical power transmission system cycle and draws energy from an energy source in a second portion of the mechanical power transmission system cycle. For instance, energy may be generated by the electrical drive motor 94 of the juice extractor machine 40 during a downward cup stroke of the upper cup assembly performed by the cam-operated drive system 84. The electrical drive motor 94 may act as a generator as it controls or reduces the downward speed of the upper cup assembly, as is well known in the art.

In other examples, energy may be generated by the electrical drive motor 94 of the juice extractor machine 40 during an upward, return cup stroke of the upper cup assembly performed by the cam-operated drive system 84 in combination with the return biasing subassembly 120. The electrical drive motor 94 may act as a generator as it controls or reduces the upward speed of the upper cup assembly, driven by the force of the return biasing subassembly 120.

Any energy generated by the electrical drive motor 94 may be referred to as “generated energy”, “recaptured energy”, “regenerative energy”, “excess energy”, or the like. In that regard, an electrical current associated with energy generated by the electrical drive motor 94 may be referred to as “generated electrical current”, “recaptured electrical current”, “regenerative electrical current”, “excess energy electrical current”, or the like. Further, because the energy generated by the electrical drive motor 94 is pushed back to its respective VFD 140, it some instances the generated energy/generated electrical current or the like may be referred to as excess energy of the VFD.

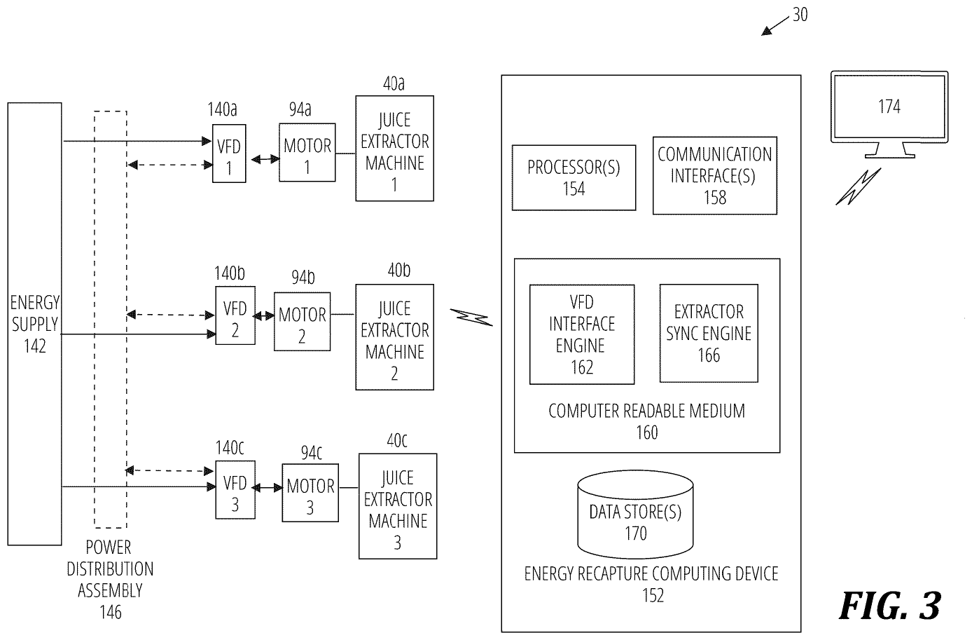

Further aspects of the energy recovery system 30 will now be described with reference to FIG. 3-10. In general, the energy recovery system 30 is configured to capture energy generated by the electrical drive motor 94 during at least one mechanical power transmission system cycle of a machine, such as the juice extractor machines 40. Further, the energy recovery system 30 is configured to distribute the generated energy to one or more machines or other components in the juice extractor system 32 for subsequent use.

As can be seen in the schematic illustration of FIG. 3, the energy recovery system 30 is shown including first, second, and third juice extractor machines 40a, 40b, and 40c with corresponding first, second, and third VFDs 140a, 140b, and 140c. Each of the first, second, and third VFDs 140a, 140b, and 140c are electrically connected intermediate corresponding first, second, and third electrical motors 94a, 94b, and 94c and an energy supply 142, such as an AC mains. It should be appreciated that fewer or more than three juice extractor machines/motors and corresponding VFDs may instead be used.

Each of the first, second, and third VFDs 140a, 140b, and 140c may store drawn energy in a capacitor and convert the stored energy to an AC current supplied to the corresponding first, second, and third electrical motors 94a, 94b, and 94c. The VFDs 140a, 140b, and 140c may also adjust the output speed of the electrical drive motor 94 by varying the frequency and voltage of the input electricity to the corresponding motor to meet the electrical needs of the machine. For instance, the output speed of the electrical drive motors 94a, 94b, and 94c is varied to meet the needs of the corresponding machine mechanical power transmission system (e.g., the cam-operated drive system 84) for performing the downward or the upward stroke of the juicing process.

Each of the first, second, and third VFDs 140a, 140b, and 140c are also configured to receive energy generated during operation of the corresponding juice extractor machine, such as during a first portion of a mechanical power transmission system cycle. As noted above, the first portion of a mechanical power transmission system cycle may be defined by the downward stroke(s) of the cam-operated drive system 84 (e.g., a downward cup stroke of the upper cup assembly).

As is well known, excess system energy, such as energy generated by the electrical motor, may be dissipated as heat, and/or it may be reused as energy for the system or connected components. When the motor controlled by the VFD acts as a generator or the VFD is being used to decelerate the motor, the DC bus voltage of the VFD rises, leading to over-voltage faults if the generated energy is not dissipated or reused.

To dissipate the excess system energy as heat, power dissipation devices, such as brake resistors can be added to the VFDs. A braking resistor will dissipate excess energy by converting it to heat across a resistor element. Braking resistors are introduced into a motor control system in order to prevent hardware damage and/or nuisance faults in a VFD. The amount of excess energy that can be dissipated by a VFD brake resistor is limited by the specifications of the VFD brake resistor, including power dissipation (PD) capacity, or how much power they can safely dissipate if used continuously (e.g., the cumulative number of seconds the resistor is used over a certain number of minutes).

In the alternative or in addition thereto, the excess energy may be reused as energy for the system or connected components. The exemplary energy recovery system 30 of the present disclosure includes electrically coupling the respective VFDs of the plurality of juice extractor machine motors to a power distribution assembly 146 such that recovered energy is pooled for use by any of the coupled juice extractor machine motors.

The power distribution assembly 146 is generally configured to receive energy generated by the motors during operation of the juice extractor machines and distribute the generated energy to machine motors or other components of the juice extractor system 32. The power distribution assembly 146 may be an electrical power sink that receives excess motor energy, in addition to or instead of a brake resistor or the like. Further, any electrical device (such as the machine motors) electrically coupled to the power distribution assembly 146 may receive or otherwise draw excess energy from the power distribution assembly 146 for energy reuse.

FIG. 3 shows the power distribution assembly 146 located electrically intermediate the first, second, and third VFDs 140a, 140b, and 140c and the corresponding first, second, and third electrical drive motors 94a, 94b, and 94c. In the example depicted, each of the first, second, and third VFDs 140a, 140b, and 140c and the first, second, and third electrical drive motors 94a, 94b, and 94c are connected in parallel to the power distribution assembly 146. In this manner, generated energy of the machine motors is dissipated into the power distribution assembly 146 and pooled for use by other electrical devices. The pooled, generated energy can be used directly by one of the other VFDs coupled to the power distribution assembly 146 that requires energy.

In one example, the power distribution assembly 146 is configured at least in part as a common DC bus. In some examples, each VFD 140a, 140b, and 140c is configured as a DC-AC drive with a DC bus, and the DC bus of each VFD is electrically connected with suitable electrical connections to form the common DC bus. Energy generated by any of the electrically coupled machine motors is dissipated onto the common DC bus and pooled for use by other devices. With the VFDs of each motor/machine electrically connected in parallel on the common DC bus, the pooled energy may be used by any VFD(s) that requires energy for its respective motor. In that regard, the common DC bus may be configured to guide regenerative current of an electric motor(s) to one or more other VFDs for supplying power to the respective motor.

Each VFD in the energy recovery system 30 may be configured to match a power signature of another VFD or electrical component from which it receives power. As the electrical components of machines may differ, their power signatures may be different. A “power signature” may include a current output, the cosine wave associated with the electrical output or input, a voltage or current the machine is designed to operate with, etc. The electrical components of machines may damage if they are electrically connected to other machines with different power signatures. Therefore, the VFDs may be configured to match the power signature of the other VFDs in the energy recovery system 30 from which it receives power.

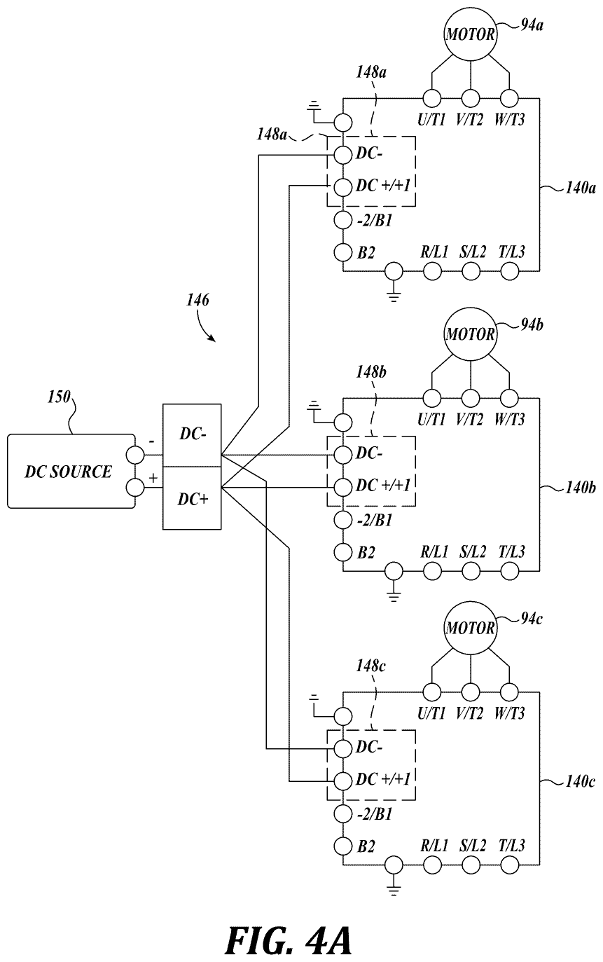

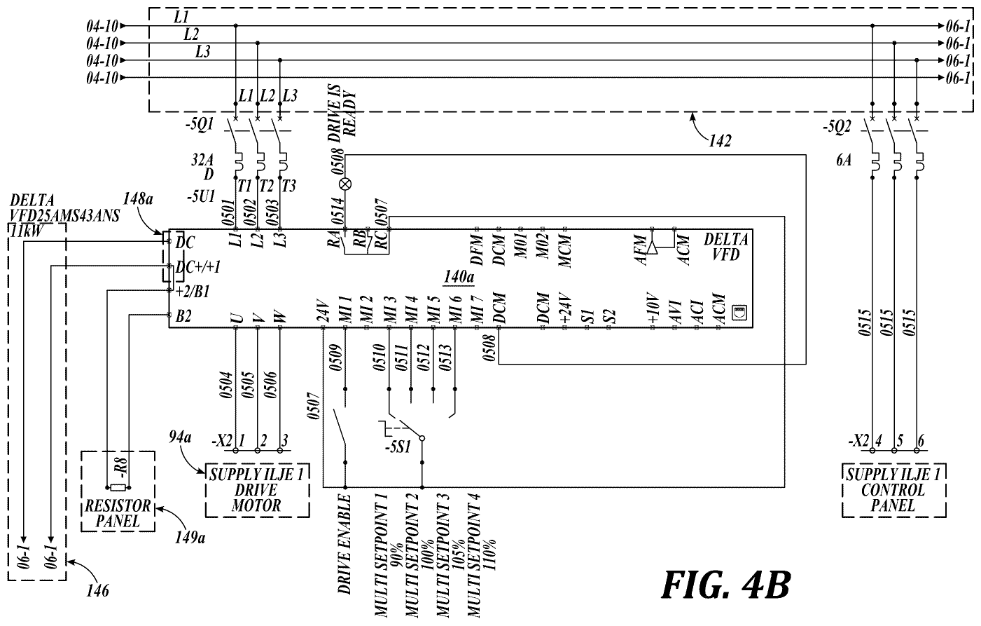

FIG. 4A shows an exemplary electrical diagram of at least a portion of the energy recovery system 30. As shown, first, second, and third VFDs 140a, 140b, and 140c are each connected to corresponding first, second, and third electrical drive motors 94a, 94b, and 94c. DC bus structure of each of the first, second, and third VFDs 140a, 140b, and 140c are connected in parallel to define the power distribution assembly 146 as a common DC bus.

The DC bus structure of each of the first, second, and third VFDs 140a, 140b, and 140c may be electrically coupled to respective first, second, and third energy storage devices of the VFDs, such as first, second, and third capacitors 148a, 148b, and 148c. The first, second, and third capacitors 148a, 148b, and 148c may be considered as part of the power distribution assembly 146.

In one aspect, the capacitors 148a, 148b, and 148c of each VFD 140a, 140b, and 140c may capture and distribute/dissipate excess generated energy from its respective motors 94a, 94b, and 94c to the common DC bus of the power distribution assembly 146. In that regard, the first, second, and third capacitors 148a, 148b, and 148c may collectively and/or individually define a power sink for pooling the generated energy of the energy recovery system 30.

In a further aspect, the capacitors 148a, 148b, and 148c of each VFD 140a, 140b, and 140c may capture and store energy retrieved from the DC common bus for use in powering its respective motor 94a, 94b, and 94c. In that regard, excess energy may flow into and out of the capacitors 148a, 148b, and 148c for distributing power to one of the motors 94a, 94b, and 94c. When at least two of the machines 40a, 40b, and 40c are running, the excess energy may essentially constantly flow between the respective VFDs to provide power to the corresponding motors where needed, without being stored.

In some examples, an energy storage device may also be coupled to the power distribution assembly 146 for storing any excess generated energy for use by the VFDs 140a, 140b, and 140c. For instance, FIG. 4A shows an energy storage device 150 coupled to the power distribution assembly 146 for storing any energy captured by the electrically connected VFDs. The energy storage device 150 may capture and store generated energy for use by other machines or components of the juice extractor system 32. The energy storage device 150 may be any suitable source of DC electrical energy, such as a battery, a capacitor, etc.

FIG. 4B shows an exemplary electrical diagram of at least a portion of the energy recovery system 30 showing a first VFD 140a, to which the first electrical drive motor 94a is coupled. The first VFD 140a is shown coupled to an energy supply 142, such as an AC three-phase power supply line. The first VFD 140a includes a first capacitor 148a electrically coupled to common DC bus structure of the power distribution assembly 146. A first power dissipated device embodied as a first brake resistor 149a is electrically coupled to the first VFD 140a.

Energy generated by the first electrical drive motor 94a may be stored by the first capacitor 148a for distribution to the power distribution assembly 146 (for supplying power to other VFDs coupled thereto). At the same time, the first capacitor 148a may draw and store energy from the power distribution assembly 146 for supplying power to the first electrical drive motor 94a.

Electrical diagrams of other portions of the energy recovery system 30, e.g., for the second and third VFDs 140a and 140b and their corresponding electrically connected components, may be similar to that shown in FIG. 4B.

The energy recovery system 30 may be configured to guide power originating from a power source different than the electrical supply to one or more of the electric motors. For example, the energy of regenerative current of an electric motor(s) may be stored in a capacitor of its respective VFD(s) and drawn by or pushed to one or more other VFDs via the common DC bus.

Guiding the power originating from a different power source, such as another motor/VFD, may include drawing energy from the different power source, storing it in a capacitor of at least one VFD, and converting the stored energy to an alternating (AC) current, which it supplies to the corresponding electric motor(s). Alternatively, if the different power source provides DC current to a VFD(s), the VFD(s) may be configured to directly store energy associated with the received DC current in a capacitor and convert the stored energy to an AC current, which it supplies to the corresponding electric motor(s).

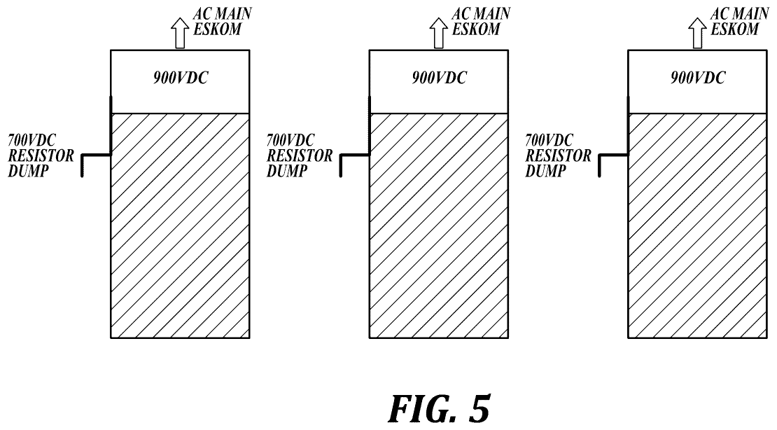

An overview of generated energy flow within an energy recovery system like the energy recovery system 30 described herein will now be described with reference to FIGS. 5-8. To help illustrate the benefits of the energy recovery system 30, a description of a system that merely uses power dissipation devices, such as brake resistors, will first be described with reference to FIG. 5.

FIG. 5 is a schematic illustration of generated energy flow for a system using a plurality of machine motors electrically coupled to corresponding VFDs, with each VFD having a brake resistor (labeled as “Resistor Dump”). Each VFD brake resistor is configured to dissipate excess energy produced by the electrical motor. The excess energy may be generated during a first portion of a mechanical power transmission system cycle of the machines, such as during a downward stroke(s) of the cam-operated drive systems 84 of juice extractor machines 40.

In the example shown, the VFD brake resistors each have a power dissipation capacity of about 700 VDC. However, the electrical motors of each of the machines generate about 900 VDC in excess energy. Accordingly, in the example shown, about 200 VDC cannot be dissipated as heat. Excess energy that cannot be dissipated as heat may be pushed back into the electrical grid line (e.g., an AC mains, labelled as “AC MAIN ESKOM” in FIG. 5). Both the generated energy that is dissipated as heat and the generated energy that is pushed back into the electrical grid line is wasted energy.

Moreover, although not schematically depicted, the juice extractor electrical motors often generate energy at a higher rate than what can be dissipated by the VFD brake resistor. In one specific example, the juice extractor electrical motors of each of the machines generate energy about one third (⅓) of the time they are running, whereas the VFD brake resistor is specified to dissipate energy (e.g., 700 VDC) during about one fifth of the VFD running time.

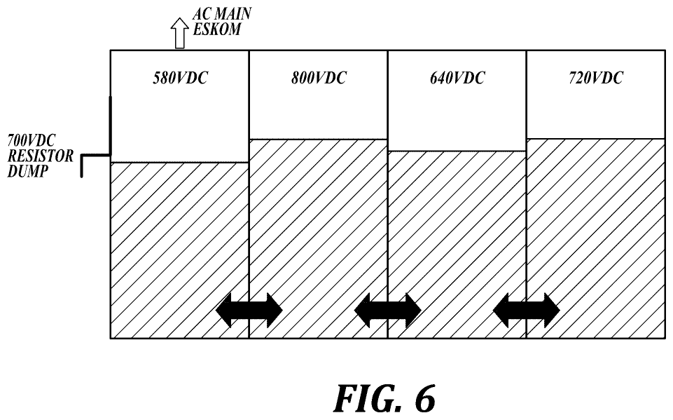

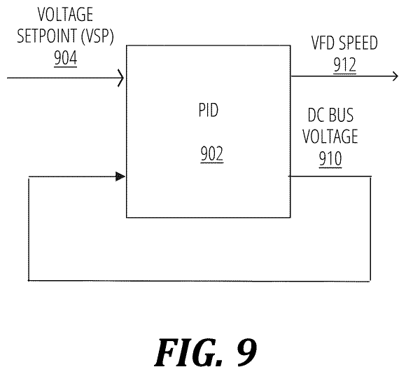

Accordingly, in the example of FIG. 5, excess energy generated by the electrical motor is wasted as heat or electrical grid pushback, and/or the excess energy may cause VFD hardware damage, nuisance faults, etc. The schematic illustrations of FIGS. 6 and 9 demonstrate benefits realized by the systems and methods disclosed herein, such as minimizing VFD damage and optimizing system energy use.

FIG. 6 is a schematic illustration of generated energy flow for an energy recovery system having a plurality of motors electrically coupled to corresponding VFDs that are connected in parallel to a power distribution assembly, such as a common DC bus. In that regard, the energy recovery system exemplified in FIG. 6 may be similar to the energy recovery system 30 described above with respect to FIGS. 3 and 4.

Each VFD may be electrically coupled to a VFD brake resistor, although only a single VFD brake resistor is shown. In that regard, in some examples a VFD brake resistor may be coupled to the power distribution assembly (e.g., the common DC bus) for dissipating some or all of the excess pooled energy of the energy recovery system. In any event, the VFD brake resistor(s) may have a power dissipation capacity suitable to prevent excess voltage from damaging the electrically connected VFDs. For instance, the VFD brake resistor(s) may have substantially the same specifications as described above with respect to FIG. 5 (e.g., specified to dissipate a certain amount of energy (e.g., 700 VDC per VFD) during about one fifth of the VFD running time).

With the VFDs of each motor/machine connected together in parallel to the power distribution assembly (e.g., on a common DC bus), excess generated energy by the machine motors may be dissipated onto the power distribution assembly and pooled for use by other machines. The pooled, generated energy can be used directly by one of the other VFDs coupled to the power distribution assembly that requires energy. Any excess energy not absorbed by machines coupled to the power distribution assembly 146 can be dissipated through the VFD brake resistor (“Resistor Dump”) or pushed back to the electrical grid, as shown in FIG. 6. With at least some of the generated energy absorbed by machines coupled to the power distribution assembly, the total amount of energy required by the juice extractor system 32 is reduced.

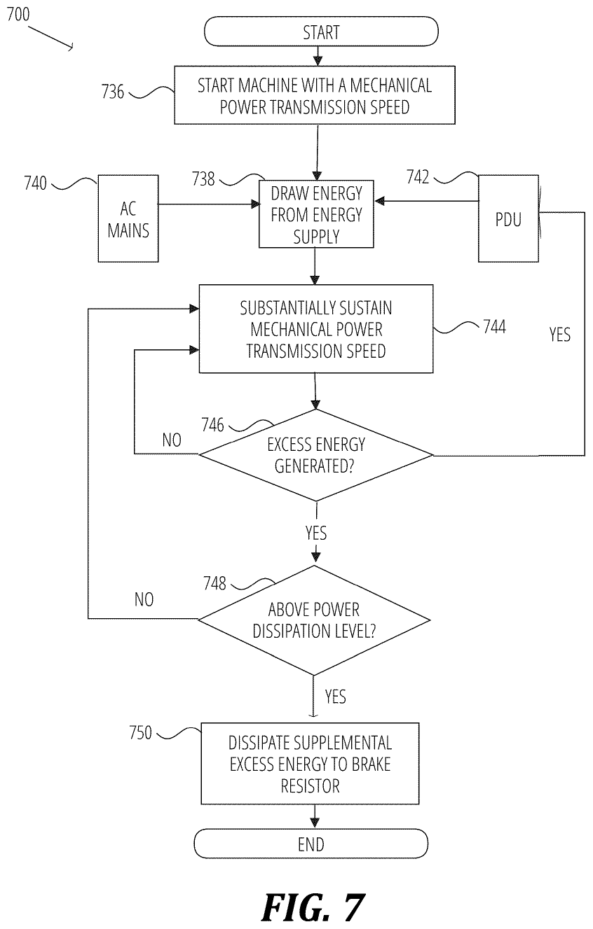

FIG. 7 depicts a method 700 of reusing energy in accordance with examples disclosed herein. The method 700 may be carried out using any of the systems described herein, such as the systems described with reference to FIGS. 1-4 and 6. In that regard, the method 700 may be carried out for an energy recovery system 30 used for a juice extractor system 32 having a plurality of juice extractor machines 40. Further, the method 700 may be carried out using any other suitable systems.

From a start block, the method 700 may include, at step 736, starting a plurality of machines each powered by VFDs that are coupled to a power distribution assembly, such as a common DC bus. Each of the machines may be set to run at mechanical power transmission speeds that are predetermined according to the processing requirements or other operational requirements of the machine or the plant or facility in which the machine is being used. For instance, VFDs 140 of juice extractor machines 40 may be started and set to run their electrical drive motors 94 at a specific speed to produce a desired throughput of juice within a certain time frame.

In some examples, a controller or computing device integrated in or otherwise coupled to the machine VFDs carries out a computer-implemented starting sequence whereby a machine(s) in the system may be activated to perform a mechanical power transmission cycle to produce regenerative energy before another machine(s) in the system is activated. In such an example, regenerative current produced by the electrical drive motor of the activated machine(s) may be pushed to the power distribution assembly 146 (e.g., a common DC bus) to help activate and/or power one or more other machines in the system.

At step 738, the method 700 may include drawing energy from an energy supply source to the VFDs to power the machines. In a system where a VFD controls the motor of the machines and the VFDs are coupled in parallel to a power distribution assembly 146, such as a common DC bus, the energy may be drawn from an AC supply, such as an AC mains 740 and/or the power distribution assembly (labeled as PDU 742 in FIG. 7). Although step 736 is stated as “drawing” energy from a source to the VFDs, it should be understood that step 736 may also or instead include “supplying” energy to the VFDs.

At step 744, the method 700 may include controlling the motors of each of the machines to substantially sustain mechanical power transmission speed of the machines. For instance, the VFD of each machine varies the frequency and voltage of its energy supply to the motor to substantially meet a required machine speed.

At a decision step 746, the method 700 may include determining whether excess energy was generated by a machine motor(s) of the system. If excess energy was generated, the excess energy may be dissipated to the PDU 742, which can be used as energy supply for the VFDs to power the machines at step 738. If excess energy was not generated, then the method may include continuing to substantially sustain mechanical power transmission speed of the machines at step 744.

If excess energy is generated at step 744, the method 700 may also include determining if the excess energy is above a predetermined power dissipation level of the VFD(s), such as above a level of a brake resistor of the VFD(s). At step 750, excess energy above a predetermined power dissipation level of the VFD(s) (“supplemental excess energy”) may be dissipated to a power dissipation device, such as a brake resistor of the VFD(s).

In the example shown in FIG. 6, which may be used generally in accordance with the method 700 described above, the electrical motors of each of first, second, third, and fourth machines generate an average level of excess energy of about 580 VDC, 800 VDC, 640 VDC, and 720 VDC, respectively. Because some of the excess energy can be used by motors coupled to the power distribution assembly through their respective VFDs, the average level of excess energy for each machine will be lower than, for instance, a system using only brake resistors, such as the system shown in FIG. 5 (where each machine had an excess energy level of about 900 VDC).

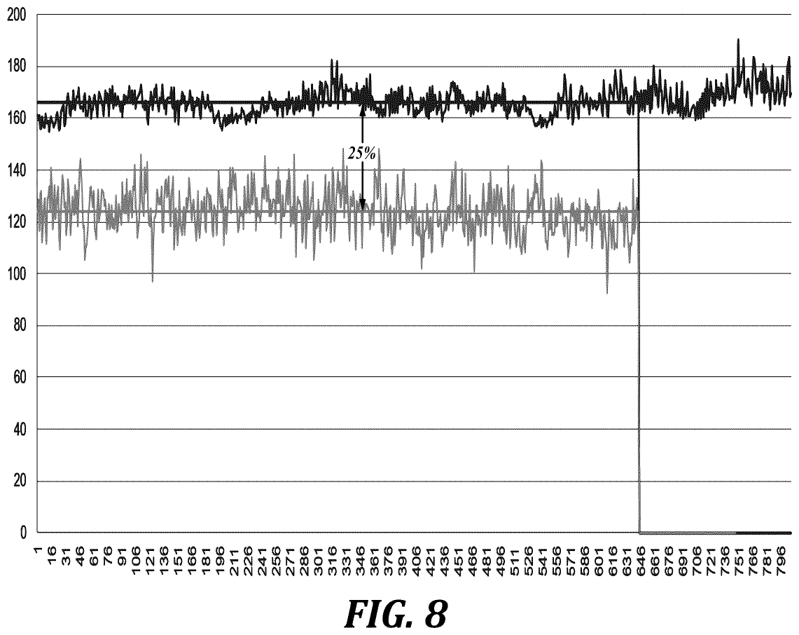

FIG. 8 shows a graphical illustration of energy consumption of a juice extractor system similar to that shown in FIG. 5, e.g., with each juice extractor machine having a motor tied to an individual VFD, compared to the reduced energy consumption of a juice extractor system similar to that shown in FIG. 6, e.g., with each juice extractor machine having a motor tied to a VFD on a common DC bus. For this measurement, each system included the same number of machines/motors/VFDs/etc.

The total energy consumed by the system having machines with a motor tied to an individual VFD (like the system shown in FIG. 5) was measured to be about 166 Amps over the period of time (or number of cycles) measured. By comparison, the total energy consumed by the system having machines with a motor tied to a VFD on a common DC bus (like the system shown in FIG. 6) was measured to be about 123 Amps over the period of time (or number of cycles) measured. As can be seen, a total energy savings of about 42 Amps, or an energy use reduction of about 25%, was realized using a juice extractor system similar to that shown in FIG. 6, with each juice extractor machine having a motor tied to a VFD on a common DC bus.

The amount of excess energy generated and consumed by machines in the system may be dependent, at least in part, on the speed of the mechanical power transmission cycles of each of the machines. In the example shown in FIG. 6, the machine mechanical power transmission cycles of each of the machines are generally operating out of phase or not synchronized. Synchronization of machine mechanical power transmission cycles may include substantially matching a cycle speed of the machines such that the machines perform the same amount of mechanical power transmission cycles per interval of time.

Using the juice extractor machine 40 as an example, synchronization may indicate that the amount of the downward strokes per interval of time for the machines are substantially equal. Of note, the downward strokes of the machines need not necessarily occur simultaneously or in unison. Similarly, the upward strokes of the machines need not necessarily occur simultaneously or in unison. Rather, synchronization may indicate that the amount of the upward strokes per interval of time for the machines are substantially equal. In some examples, however, the downward stroke and upward stroke of the machine are synchronised such that they occur in unison.

As noted above, a motor may generate excess energy each time a first portion of a mechanical power transmission cycle is completed. If more cycles are completed per unit of time, more energy is generated per unit of time. At the same time, more energy is required per unit of time to run the machine at the higher speeds. At least some of the required energy can come from the excess energy generated by a machine motor that is fed into the power distribution assembly 146.

The amount of excess energy consumed by the machine VFDs may depend on the mechanical power transmission cycle speeds of the machines. For instance, a machine running at a lower mechanical power transmission cycle speed may not consume as much energy as a machine running at a higher mechanical power transmission cycle speed. At the same time, the machine running at a lower mechanical power transmission cycle speed generates less energy for distribution to the power distribution assembly 146.

In some examples, systems and methods disclosed herein may be used to optimize energy recovery of a machine system by substantially synchronizing mechanical power transmission cycles of the machines coupled to the power distribution assembly at a predetermined speed. The machine motors can be synchronized at a predetermined speed to generate an optimal amount of excess energy that is dissipated to the DC common bus. An optimal amount of excess energy that is dissipated to the DC common bus may be, for instance, an amount of excess energy that can be substantially consumed by the system with substantially little to no excess energy dissipated as heat or pushed back to the AC mains.

In the systems described herein, the DC bus of each VFD in the system is electrically coupled to the power distribution assembly 146, which may be a common DC bus. The excess energy level may therefore be the energy or voltage level of the DC common bus.

Energy recovery optimization may include achieving a target DC common bus voltage level and then substantially maintaining that voltage level of the DC common bus. The target DC common bus voltage level may be at about the level at which the VFD dissipates power as heat rather than reusing the energy and/or at a level below VFD power dissipation. For instance, the target DC common bus voltage level may be defined by the power dissipation capacity of the VFD brake resistors. In that regard, the target DC common bus voltage level may be at or below the power dissipation capacity of the VFD.

Reaching and thereafter maintaining a target DC common bus voltage level can be achieved by controlling the output electrical energy of the VFD. Controlling the output electrical energy of the VFD may include adjusting a speed of the VFD to substantially achieve a target DC common bus voltage level. More specifically, the DC common bus voltage is decreased or increased by increasing or decreasing the speed of the VFD(s), respectively.

As each of the VFDs in the system adjusts its speed to achieve the target DC common bus voltage level, the machines are brought into substantial synchronization. As noted above, synchronization of machine mechanical power transmission cycles may include substantially matching a cycle speed of the machines such that the machines perform the same amount of mechanical power transmission cycles per interval of time.

Maintaining a target DC common bus voltage level can be achieved by continuously adjusting a speed of the VFD as needed to increase or decrease the DC common bus voltage level relative to the target level. If a machine(s) of the system is shut down during production, the remaining operating machines can be adjusted in VFD output speed to again achieve and maintain the target DC common bus voltage level.

A control device communicatively coupled to or otherwise integrated into each VFD may be used to reaching and thereafter maintaining a target DC common bus voltage level, substantially synchronizing machine mechanical power transmission cycles of each of the machines. For instance, each VFD may include a proportional-integral-derivative (PID) controller that uses a control loop module to control output electrical energy to the corresponding motor of the VFD in accordance with predetermined criteria. By controlling the output electrical energy to the motor of the VFD, the target DC common bus voltage level (and the rate of the mechanical power transmission cycle of the machines) may be controlled.

The target DC common bus voltage level may define a VFD DC bus voltage setpoint (or more generally an “energy level setpoint”), which may be programmed into the PID controller, for instance, using a computing device (e.g., an HMI) integrated into the VFD or otherwise in communication with the PID controller. The speed of the VFD (Hz) may be controlled (e.g., increased or decreased in response to instructions from the PID controller) to substantially maintain a DC bus voltage level at about or below the VFD DC bus voltage setpoint.

A simplified, schematic diagram of a PID control loop is shown in FIG. 9. A VFD DC bus voltage setpoint (VSP) 904 is programmed into a PID controller 902, such as through an HMI. Once the VFD is started, the VFD outputs energy at a certain VFD speed 912, which causes the motor to generate excess energy and produce a resultant VFD DC bus voltage 910 (which is substantially the same as a DC common bus voltage level when coupled thereto). The level of the VFD DC bus voltage 910 is fed back into the PID controller 902 such that the PID controller 902 can adjust the VFD speed 912 to achieve a DC bus voltage at substantially the level of the VFD DC bus voltage setpoint (VSP) 904.

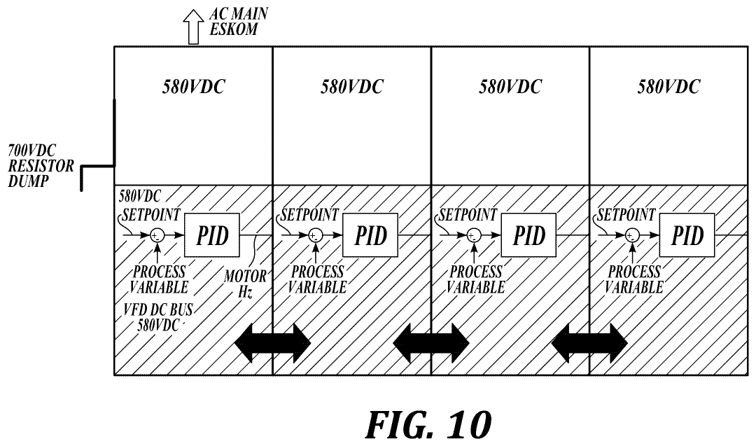

FIG. 10 is a schematic illustration of energy flow for an energy recovery system using a plurality of machines having motors electrically coupled to corresponding VFDs that are connected together by a power distribution assembly 146, such as on a common DC bus. Further, a PID controller of each VFD, shown schematically as a PID control loop, is used to control the VFD speed relative to a VFD DC bus voltage setpoint to substantially synchronize the machines at a target speed for increased energy savings.

Each VFD may be electrically coupled to a VFD brake resistor, although only a single VFD brake resistor is shown. In that regard, in some examples a VFD brake resistor may be coupled to the power distribution assembly (e.g., the common DC bus) for dissipating some or all of the excess pooled energy of the energy recovery system. In any event, the VFD brake resistor(s) may have any suitable specifications, such as substantially the same specifications as described above with respect to FIG. 5 (e.g., specified to dissipate energy (e.g., 700 VDC) during about one fifth of the running time).

In some examples, the machines may be manually started together to cause synchronous movements for energy recovery and usage optimization. However, as is typical in juicing plants, multiple machines are used to support a production line. It is common that one or more of the machines are turned off (and likely locked out/tagged out) during production for maintenance, troubleshooting, changeover, etc. In that regard, for at least safety and efficiency reasons, it is beneficial to instead synchronize the machines electronically as described herein.

In the example depicted in FIG. 10, the power dissipation capacity of the VFD brake resistor(s) is 700 VDC. The speed of each of the VFDs is increased or decreased to substantially achieve and maintain a VFD DC common bus voltage level at or below the power dissipation capacity of the VFD brake resistor, e.g., at about 580 VDC. In one example of four juice extractor machines 40 having respective VFDs on a common DC bus, the speed of the VFD may change between 45 Hz-55 Hz according to its VFD DC bus voltage and following a setpoint of 580 VDC.

When the machines of a juice extractor system move substantially in sync or in phase, the use of regenerative energy in the system is maximized. For instance, as can be seen in FIG. 10, the excess energy of the motors dissipated to the power distribution assembly (e.g., the DC common bus) stays substantially below the power dissipation capacity of the VFD brake resistor (e.g., about 700 VDC). In that regard, the excess generated energy is well within specification limits of the VFD brake resistor and substantially all of the excess energy is reused by the system. Little to no excess energy is dissipated through the VFD brake resistor. Moreover, hardware damage and/or nuisance faults in the system VFDs is minimized or avoided entirely.

Through experimentation, the inventors found an increase of about eight percent (8%) energy savings using a system like that shown in FIG. 10 (motor tied to a VFD on a common DC bus with a PID controller programmed to output a set DC bus voltage to substantially synchronize the machines) compared to the juice extractor systems of FIG. 6 (no PID controlling the output voltage to a setpoint).

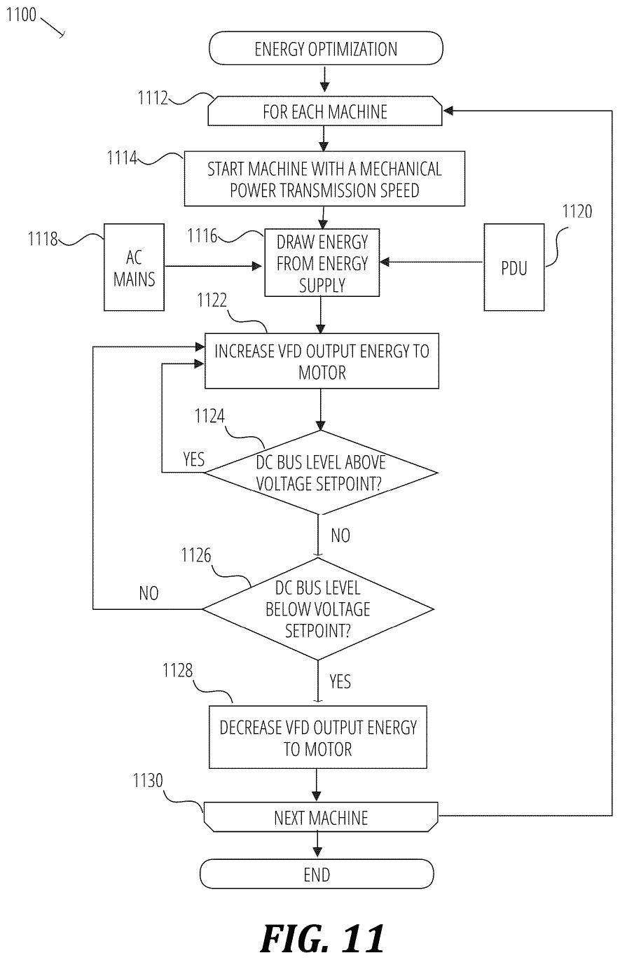

A method of optimizing energy usage of a juice extractor system will now be described with respect to FIG. 11. The method 1100 may be carried out using any of the systems described herein, such as the systems described with reference to FIGS. 1-4 and 10. In that regard, the method 1100 may be carried out for an energy recovery system 30 used for a juice extractor system 32 having a plurality of juice extractor machines 40, each powered by a VFD that is coupled to a power distribution assembly 146, such as a DC common bus. Further, the method 1100 may be carried out using any other suitable systems.

From a start block, a loop may begin as step 1112, wherein a machine having a VFD coupled in parallel to a power distribution assembly, such as a DC common bus, is started at block 1114. When the machine is started, it has a mechanical power transmission system speed. The speed of the mechanical power transmission system is determined, for instance, by the speed of the electrical motor and/or the output speed of the VFD powering the mechanical power transmission system.

At step 1116, the method 700 may include drawing energy from an energy supply source to the VFDs to power the machines. In a system where a VFD controls the motor of the machines and the VFDs are coupled in parallel to a power distribution assembly 146, such as a common DC bus, the energy may be drawn from an AC supply, such as an AC mains 1118 and/or the power distribution assembly (labeled as PDU 1120 in FIG. 11). Although step 1116 is stated as “drawing” energy from a source to the VFD, it should be understood that step 1116 may also or instead include “supplying” energy to the VFD.

At step 1122, the method 700 may include increasing VFD output energy, or increasing the speed of the VFD to corresponding increase the speed of the electrical motor coupled thereto. As the VFD output speed is increased, excess energy may be generated by the corresponding motor, and a resultant VFD DC bus voltage (which is substantially the same as a DC common bus voltage level when coupled thereto) may be generated.

The level of the VFD DC bus voltage may be fed back into a PID controller of the VFD such that the PID controller 902 can adjust the VFD speed to achieve a DC bus voltage at substantially a level of a VFD DC bus voltage setpoint. If, at decision block 1124, the VFD DC bus voltage level is above the VFD DC bus voltage setpoint, the method may include increasing the VFD output energy to the motor again at step 1122 to decrease the VFD DC bus voltage level.

If, at decision block 1124, the VFD DC bus voltage level is not above the VFD DC bus voltage setpoint, the method may include determining whether the VFD DC bus voltage level is below the VFD DC bus voltage setpoint at decision block 1126. If the VFD DC bus voltage level is below the VFD DC bus voltage setpoint, the method may include decreasing the VFD output energy to the motor at step 1122 to decrease the VFD DC bus voltage level.

The method may then proceed to carrying out the above steps for a next machine when the loop ends at step 1130. When the machines are no longer being used, such as at an end of a production/operation run, the method may end and be restarted for a subsequent production run or operation.

As noted above, the PID controller is programmed to output a DC voltage to the motor that is set, for instance, using a computing device (e.g., HMI) in communication with the PID controller(s), which may be incorporated into the energy recovery system 30. For instance, FIG. 3 shows a non-limiting example of an energy recapture computing device 152 in networked communication with the PID controller(s) of the VFDs and/or the machines. The exemplary energy recapture computing device 152 includes a processor(s) 154, a communication interface(s) 158, a computer readable medium 160, and a data store(s) 170.

The energy recapture computing device 152 may be implemented by any computing device or collection of computing devices, including but not limited to a desktop computing device, a laptop computing device, a mobile computing device, a server computing device, a computing device of a cloud computing system, an edge computing device, and/or combinations thereof. In some embodiments, the processor(s) 154 may include any suitable type of general-purpose computer processor. In some embodiments, the processor(s) 154 may include one or more special-purpose computer processors or AI accelerators optimized for specific computing tasks, including but not limited to graphical processing units (GPUs), vision processing units (VPTs), and tensor processing units (TPUs).

In some embodiments, the communication interface(s) 158 include one or more hardware and or software interfaces suitable for providing communication links between components. The communication interface(s) 158 may support one or more wired communication technologies (including but not limited to Ethernet, FireWire, and USB), one or more wireless communication technologies (including but not limited to Wi-Fi, WiMAX, Bluetooth, 2G, 3G, 4G, 5G, and LTE), and/or combinations thereof.

As shown, the computer-readable medium 160 has stored thereon logic that, in response to execution by the one or more processor(s) 154, cause the energy recapture computing device 152 to provide a VFD interface engine 162 and an extractor sync engine 166.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

As used herein, “engine” refers to logic embodied in hardware or software instructions, which can be written in one or more programming languages, including but not limited to C, C++, C #, COBOL, JAVA™, PHP, Perl, HTML, CSS, Javascript, VBScript, ASPX, Go, and Python. An engine may be compiled into executable programs or written in interpreted programming languages. Software engines may be callable from other engines or from themselves. Generally, the engines described herein refer to logical modules that can be merged with other engines or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

The VFD interface engine 162 of the energy recapture computing device 152 may be configured to provide an interface to the VFD controller and/or an interface to operational aspects of the VFD, such as through a display provided on a computing device 174 (e.g., an HMI). A user may interface with the VFD interface engine 162, for instance, to adjust a setpoint of the DC bus output voltage of a VFD(s) in the energy recovery system 30.

The extractor sync engine 166 of the energy recapture computing device 152 may be configured to optimize energy usage of a juice extractor system, such as by implementing an algorithm in the PID controllers of the VFDs in accordance with the method described above with respect to FIG. 11. For instance, the extractor sync engine 166 may be used to determine a DC bus voltage level setpoint based upon, for instance, a VFD power dissipation level for the VFDs (e.g., a VFD brake resistor level). In the alternative or in addition thereto, the extractor sync engine 166 may be used to retrieve and/or store a DC bus voltage level setpoint from the store(s) 170, which may be specific to the VFD power dissipation capacity, the production throughput, the machine capacities, or other factors.

The extractor sync engine 166 may be used to program the PID to adjust the output energy or speed of the VFD to achieve and substantially maintain the DC bus voltage level setpoint for some or all of the machines coupled to, e.g., a common DC bus or other power distribution assembly. A user may interface with the extractor sync engine 166, for instance, through a display provided on a computing device 174 (e.g., an HMI).

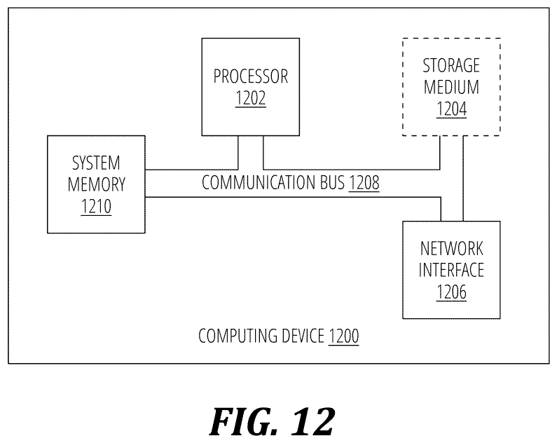

FIG. 12 is a block diagram that illustrates aspects of an exemplary computing device 1200 appropriate for use as a computing device of the present disclosure. While multiple different types of computing devices were discussed above, the exemplary computing device 1200 describes various elements that are common to many different types of computing devices. While FIG. 12 is described with reference to a computing device that is implemented as a device on a network, the description below is applicable to servers, personal computers, mobile phones, smart phones, tablet computers, embedded computing devices, and other devices that may be used to implement portions of examples of the present disclosure. Some examples of a computing device may be implemented in or may include an application-specific integrated circuit (ASIC), a field-programmable gate array (FPGA), or other customized device. Moreover, those of ordinary skill in the art and others will recognize that the computing device 1200 may be any one of any number of currently available or yet to be developed devices.

In its most basic configuration, the computing device 1200 includes at least one processor 1202 and a system memory 1210 connected by a communication bus 1208. Depending on the exact configuration and type of device, the system memory 1210 may be volatile or nonvolatile memory, such as read only memory (“ROM”), random access memory (“RAM”), EEPROM, flash memory, or similar memory technology. Those of ordinary skill in the art and others will recognize that system memory 1210 typically stores data and/or program modules that are immediately accessible to and/or currently being operated on by the processor 1202. In this regard, the processor 1202 may serve as a computational center of the computing device 1200 by supporting the execution of instructions.

As further illustrated in FIG. 12, the computing device 1200 may include a network interface 1206 comprising one or more components for communicating with other devices over a network. Examples of the present disclosure may access basic services that utilize the network interface 1206 to perform communications using common network protocols. The network interface 1206 may also include a wireless network interface configured to communicate via one or more wireless communication protocols, such as Wi-Fi, 2G, 3G, LTE, WiMAX, Bluetooth, Bluetooth low energy, and/or the like. As will be appreciated by one of ordinary skill in the art, the network interface 1206 illustrated in FIG. 12 may represent one or more wireless interfaces or physical communication interfaces described and illustrated above with respect to particular components of the computing device 1200.

In the exemplary example depicted in FIG. 12, the computing device 1200 also includes a storage medium 1204. However, services may be accessed using a computing device that does not include means for persisting data to a local storage medium. Therefore, the storage medium 1204 depicted in FIG. 12 is represented with a dashed line to indicate that the storage medium 1204 is optional. In any event, the storage medium 1204 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

Suitable implementations of computing devices that include a processor 1202, system memory 1210, communication bus 1208, storage medium 1204, and network interface 1206 are known and commercially available. For ease of illustration and because it is not important for an understanding of the claimed subject matter, FIG. 12 does not show some of the typical components of many computing devices. In this regard, the computing device 1200 may include input devices, such as a keyboard, keypad, mouse, microphone, touch input device, touch screen, tablet, and/or the like. Such input devices may be coupled to the computing device 1200 by wired or wireless connections including RF, infrared, serial, parallel, Bluetooth, Bluetooth low energy, USB, or other suitable connections protocols using wireless or physical connections. Similarly, the computing device 1200 may also include output devices such as a display, speakers, printer, etc. Since these devices are well known in the art, they are not illustrated or described further herein.

While the concepts of the present disclosure are susceptible to various modifications and alternative forms, specific examples thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one example,” “an example,” etc., indicate that the system or method described may include a particular feature, structure, or characteristic, but every system or method may or may not necessarily include that particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

Language such as “up”, “down”, “left”, “right”, “first”, “second”, etc., in the present disclosure is meant to provide orientation for the reader with reference to the drawings and is not intended to be the required orientation of the components or graphical images or to impart orientation limitations into the claims.

In the drawings, some structural or method features may be shown in specific arrangements and/or orderings. However, it should be appreciated that such specific arrangements and/or orderings may not be required. Rather, in some examples, such features may be arranged in a different manner and/or order than shown in the illustrative FIGS. Additionally, the inclusion of a structural or method feature in a particular FIG. is not meant to imply that such feature is required in all examples and, in some examples, it may not be included or may be combined with other features.

As used herein, the terms “about”, “approximately,” “substantially,” etc., in reference to a number, is used herein to include numbers that fall within a range of 10%, 5%, or 1% in either direction (greater than or less than) the number unless otherwise stated or otherwise evident from the context (except where such number would exceed 100% of a possible value).

Where electronic or software components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Headings of sections provided in this patent application and the title of this patent application are for convenience only and are not to be taken as limiting the disclosure in any way.

While preferred examples of the present invention have been shown and described herein, it will be apparent to those skilled in the art that such examples are provided by way of example only. Numerous variations, changes, and substitutions will now occur to those skilled in the art without departing from the invention. Various alternatives to the examples of the invention described herein may be employed in practicing the invention. It is intended that the following claims define the scope of the invention and that methods and structures within the scope of these claims and their equivalents be covered thereby.

The examples of the invention in which an exclusive property or privilege is claimed are defined as follows:

1. An energy recovery system for a plurality of machines each having a mechanical power transmission system, wherein each of the plurality of machines generates energy in a first portion of a mechanical power transmission system cycle and draws energy from an energy source in a second portion of the mechanical power transmission system cycle, the energy recovery system comprising:
a power distribution assembly configured to receive energy generated during the first portion of the mechanical power transmission system cycle;
a plurality of actuator controller devices configured to selectively output energy to a corresponding actuator of each of the plurality of machines, each of the plurality of actuator controller devices electrically coupled to the power distribution assembly and configured to reuse energy received by the power distribution assembly; and
a controller for each of the plurality of actuator controller devices programmed to adjust the output energy of the corresponding actuator controller device to substantially maintain a voltage level of the power distribution assembly relative to a voltage level setpoint.

2. The energy recovery system of claim 1, wherein energy generated by the plurality of machines during the first portion of the machine cycle is received by a DC common bus of the power distribution assembly.

3. The energy recovery system of claim 1, wherein the plurality of actuator controller devices are variable frequency drives (VFDs).

4. The energy recovery system of claim 1, wherein each of the actuator controller devices are coupled to the power distribution assembly in parallel such that energy generated by the plurality of machines during the first portion of the mechanical power transmission system cycle received by the power distribution assembly is accessible by any of the plurality of actuator controller devices for reuse.

5. The energy recovery system of claim 1, wherein each of the controllers is a PID controller configured to adjust an output speed of each of the corresponding actuator controller devices to substantially maintain a DC common bus voltage level of the power distribution assembly relative to the voltage level setpoint.

6. The energy recovery system of claim 1, wherein the voltage level setpoint is substantially the same as a power dissipation capacity of the power distribution assembly.

7. The energy recovery system of claim 1, wherein the voltage level setpoint is substantially the same as a VFD brake resistor power dissipation capacity of the power distribution assembly.

8. An energy recovery system, comprising:
a plurality of machines each having a mechanical power transmission system powered by an electrical motor, wherein the electrical motor of each of the plurality of machines generates energy in a first portion of a mechanical power transmission system cycle;
a DC common bus configured to receive energy generated during the first portion of the mechanical power transmission system cycle;
a plurality of variable frequency drives (VFDs) configured to selectively output energy to the corresponding electrical motor of each of the plurality of machines, each of the plurality of VFDs electrically coupled to the DC common bus and configured to reuse energy received by the DC common bus; and
a PID controller for each of the plurality of VFDs programmed to adjust the output energy of the corresponding VFD to substantially maintain a voltage level of the DC common bus relative to a voltage level setpoint.

9. The energy recovery system of claim 8, wherein each of the VFDs are coupled to the DC common bus in parallel such that energy generated by the plurality of machines during the first portion of the mechanical power transmission system cycle received by the DC common bus is accessible by any of the plurality of VFDs for reuse.

10. A method of recovering energy for a plurality of machines each having an actuator controller device that supplies energy to an actuator for moving components of the machine between a first portion of a mechanical power transmission system cycle and a second portion of a mechanical power transmission system cycle, the method comprising:
supplying output energy from each actuator controller device to the corresponding actuator;
generating energy by each of the actuators during the first portion of the mechanical power transmission system cycle of each of the plurality of machines;
dissipating generated energy below a predetermined energy level to a power distribution assembly electrically coupled to each actuator controller device; and
dissipating supplemental generated energy above the predetermined energy level to a power dissipation device.

11. The method of claim 10, wherein supplying output energy from each actuator controller device to the corresponding actuator includes at least one of drawing and supplying energy from an alternating current (AC) mains and the power distribution assembly.

12. The method of claim 10, further comprising supplying generated energy from the power distribution assembly to each actuator controller device of a machine during the second portion of the mechanical power transmission system cycle of that machine.

13. The method of claim 10, further comprising substantially synchronizing a speed of the first and second portions of the mechanical power transmission system cycles of the plurality of machines.

14. The method of claim 13, wherein substantially synchronizing the speed of the first and second portions of the mechanical power transmission system cycles of the plurality of machines includes substantially matching cycle speeds of each of the first and second portions of the mechanical power transmission system cycles per interval of time.

15. The method of claim 13, further comprising adjusting an output speed of at least one of the plurality of actuator controller devices to correspondingly adjust an energy level of the power distribution assembly relative to an energy level setpoint.

16. The method of claim 13, further comprising adjusting an output speed of at least one of the plurality of actuator controller devices to correspondingly adjust a DC common bus energy level of the power distribution assembly relative to a voltage level setpoint.

17. The method of claim 16, wherein the voltage level setpoint is substantially equal to a power dissipation capacity of each of the actuator controller devices coupled to the power distribution assembly.

18. The method of claim 16, wherein the voltage level setpoint is substantially equal to a brake resistor power dissipation capacity of each of the actuator controller devices coupled to the power distribution assembly.

19. The method of claim 10, further comprising dissipating generated energy to a DC common bus of the power distribution assembly.

20. The method of claim 19, further comprising connecting in parallel a DC bus of each of the plurality of actuator controller devices to define the DC common bus of the power distribution assembly.
